(19) United States
(12) Patent Application Publication
(10) Pub. No.: US 2024/0372232 A1
(43) Pub. Date: Nov. 7, 2024

(54) BATTERY

(71) Applicant: EVE ENERGY CO., LTD., Guangdong (CN)

(72) Inventors: Liangliang LIU, Guangdong (CN); Guangdong ZHU, Guangdong (CN); Jianhua LIU, Guangdong (CN); Jincheng LIU, Guangdong (CN)

(21) Appl. No.: 18/272,338

(22) PCT Filed: Nov. 22, 2021
(86) PCT No.: PCT/CN2021/132103

§ 371 Date: Jul. 13, 2023

(30) Foreign Application Priority Data
Jan. 13, 2021 (CN) 202120092674.4

(51) Int. Cl. H01M 50/588; H01M 50/107; H01M 50/152; H01M 50/169; H01M 50/645

(52) U.S. Cl. CPC H01M 50/588; H01M 50/107; H01M 50/152; H01M 50/169; H01M 50/645

(57) ABSTRACT

A battery includes a housing, a cell, a first cover assembly, and a second cover assembly. The housing is internally provided with a receiving chamber. The cell is mounted in the receiving chamber. The first cover assembly includes a first body and an electrode connector. The sidewall of the first body is welded to the sidewall of the housing. The second cover assembly includes a second body. The sidewall of the second body is welded to the sidewall of the housing. The opening at one of the two ends of the housing is plugged by the first cover assembly. The opening at the other of the two ends is plugged by the second cover assembly. The cell is provided with two tabs. One of the two tabs is connected to the electrode connector. The other of the two tabs is connected to the second body.

This application claims priority to Chinese Patent Application No. 202120092674.4 filed Jan. 13, 2021, the disclosure of which is incorporated herein by reference in its entirety.

### TECHNICAL FIELD

The present application relates to the field of battery technology, for example, a micro battery.

### BACKGROUND

A pin-type micro lithium-ion battery is generally sealed by side extrusion. This sealing method has the following disadvantages: 1. The side extrusion is generally achieved by slot rolling. The lithium-ion battery sealed by slot rolling occupies a large space in the diameter direction of the battery, resulting in a low inside capacity of the battery, so the diameter of the battery is limited to a minimum of about 3.6 mm in miniaturization. 2. There is no electrolyte filling hole in the battery. Typically the battery is filled with an electrolyte through a dropping method. The dropping method is difficulty in operation and is impossible to automate electrolyte filling. 3. When the seal is welded, the battery having a small diameter easily affects the stability of the central sealant layer, increasing the difficulty in welding.

### SUMMARY

The present application provides a battery. The battery is small in diameter, convenient to seal, larger in capacity in an equivalent volume, and large in energy density.

An embodiment provides a battery. The battery includes a housing, a cell, a first cover assembly, and a second cover assembly. The housing is internally provided with a receiving chamber. The cell is mounted in the receiving chamber. The first cover assembly includes a first body and an electrode connector disposed on, connected to, and insulated from the first body. The first body is configured to be inserted in the housing. The sidewall of the first body is welded to the sidewall of the housing. The second cover assembly includes a second body. The second body is configured to be inserted in the housing. The sidewall of the second body is welded to the sidewall of the housing. Two ends of the housing are each provided with an opening. The opening at one of the two ends is plugged by the first cover assembly. The opening at the other of the two ends is plugged by the second cover assembly. The cell is provided with two tabs. One of the two tabs is connected to the electrode connector. The other of the two tabs is connected to the second body.

### BRIEF DESCRIPTION OF DRAWINGS

FIG. 1 is a section view of a battery according to an embodiment of the present application.

FIG. 2 is an exploded view of a battery according to an embodiment of the present application.

FIG. 3 is a section view of a first cover assembly according to an embodiment of the present application.

FIG. 4 is an exploded view of a first cover assembly according to an embodiment of the present application.

FIG. 5 is a section view of a second cover assembly according to an embodiment of the present application.

FIG. 6 is an assembly view of a first cover assembly and a cell according to an embodiment of the present application.

FIG. 7 is an assembly view of a first cover assembly, a cell, and a housing according to an embodiment of the present application.

FIG. 8 is a weld state view of a second body of a second cover assembly and a negative tab of a cell according to an embodiment of the present application.

FIG. 9 is an assembly view of a second body and a housing according to an embodiment of the present application.

### REFERENCE LIST

1 housing
11 receiving chamber
2 cell
21 positive tab
22 negative tab
3 first cover assembly
31 first body
311 mounting hole
312 first stop
32 electrode connector
321 connection portion
322 first stop portion
33 first insulator
34 second insulator
third insulator
36 second stop portion
4 second cover assembly
41 second body
411 electrolyte filling hole
412 second stop
42 plug plate

### DETAILED DESCRIPTION

In the description of the present application, the terms “joined”, “connected”, and “fixed” are to be understood in a broad sense unless otherwise expressly specified and limited. For example, the term “connected” may refer to “fixedly connected”, “detachably connected”, or integrated, may refer to “mechanically connected” or “electrically connected”, or may refer to “connected directly”, “connected indirectly through an intermediary”, “connected inside two components”, or “interaction relations between two components”. For those of ordinary skill in the art, specific meanings of the preceding terms in the present application may be understood based on specific situations.

In the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

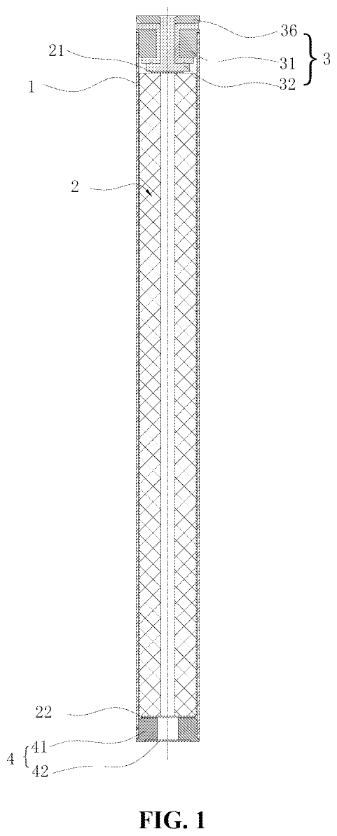

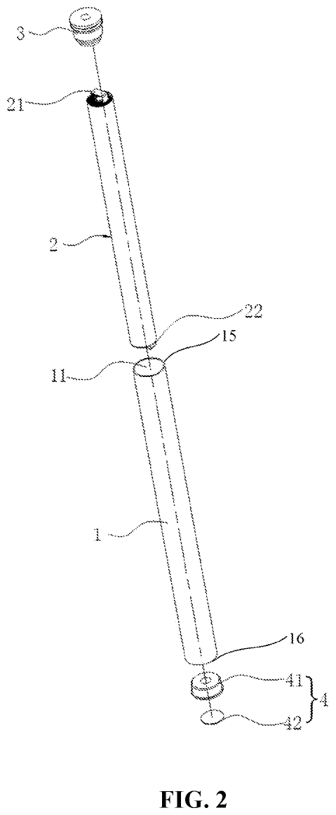

As shown in FIGS. 1 to 4, the battery of this embodiment includes a housing 1, a cell 2, a first cover assembly 3, and a second cover assembly 4. The housing 1 is internally provided with a receiving chamber 11. The cell 2 is mounted in the receiving chamber 11. Two ends of the housing 1 are each provided with an opening. The opening at one of the two ends is plugged by the first cover assembly 3. The opening at the other of the two ends is plugged by the second cover assembly 4. The first cover assembly 3 includes a first body 31. An electrode connector 32 is disposed on, connected to, and insulated from the first body 31. The first body 31 is configured to be inserted in the housing 1. The sidewall of the first body 31 is welded to the sidewall of the housing 1. The second cover assembly 4 includes a second body 41. The second body 41 is configured to be inserted in the housing 1. The sidewall of the second body 41 is welded to the sidewall of the housing 1. The cell 2 is provided with two tabs. One of the two tabs is connected to the electrode connector 32. The other of the two tabs is connected to the second body 41. The first body 31 and the second body 41 are each connected to the sidewall of the housing 1 by welding. The welding may be performed from an outer face of the sidewall of the housing 1 so that the difficulty of the welding is effectively reduced, the sealing effect is improved, and the space in the diameter direction of the battery is not occupied. Among batteries of the same size, the housing 1 of the battery of the present application has the largest space and a large energy density.

In this embodiment, the openings of the housing 1 are disposed at two ends of the housing 1 in the height direction of the housing 1.

In an embodiment, the housing is cylindrical and has a height-to-diameter ratio of greater than 2:1, for example, 3:1, 4:1, 5:1, 6:1, 7:1, 8:1, 9:1, or 10:1. In an embodiment, the diameter of the housing 1 is less than 5 mm. In other embodiments, the diameter of the housing 1 is 3 mm.

The cell 2 includes a positive tab 21 and a negative tab 22. The positive tab 21 is welded to the electrode connector 32 on the first cover assembly 3. The negative tab 22 is welded to the second body 41 of the second cover assembly 4. The welding may be laser welding or resistance welding. In other embodiments, the welding position of the positive tab 21 and the welding position of the negative tab 22 may be exchanged with each other. That is, the negative tab 22 is welded to the electrode connector 32, and the positive tab 21 is welded to the second body 41.

Additionally, to insulate the cell 2 from the housing 1, insulating pads (not shown) are disposed on the upper end face of the cell 2 and the lower end face of the cell 2 one to one. The insulating pad at the upper end of the cell 2 is located between the cell 2 and the electrode connector 32.

The insulating pad at the lower end of the cell 2 is located between the cell 2 and the second body 41.

In this embodiment, the cell 2 is a jellyroll whose axis is parallel to the central axis of the housing 1 or coincides with the central axis of the housing 1. In other embodiments, the cell 2 may also be a laminated cell.

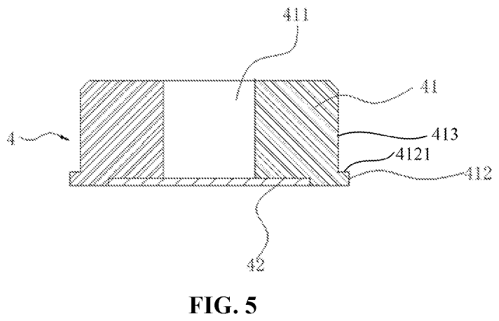

In an embodiment, as shown in FIG. 5, a electrolyte filling hole 411 extends through the second body 41 and is plugged by a plug. The electrolyte filling hole 411 of the second body 41 makes possible automatic liquid filling of the battery having a small diameter, thereby effectively reducing the electrolyte filling difficulty and increasing the electrolyte filling speed.

In this embodiment, the plug is a plug plate 42 welded to or bonded to a side side face of the second body 41 facing away from the housing 1. The plate-shaped plug can reduce the size of the battery in the height direction of the battery, reduce the manufacturing difficulty, and facilitate plugging.

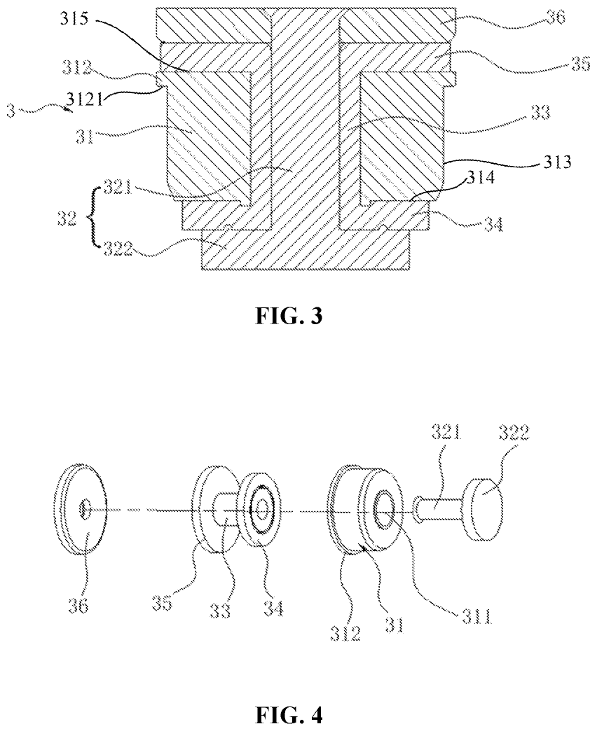

In an embodiment, as shown in FIGS. 1 and 3, a first stop 312 is disposed around the sidewall of the first body 31. The side face of the first stop 312 facing the housing 1 abuts against an end face of the housing 1. The first stop 312 can limit the position of the first cover assembly 3 when the first cover assembly 3 and the housing 1 are assembled, ensuring the accuracy of the position of the first cover assembly 3 in the housing 1.

In an embodiment, as shown in FIGS. 1 and 5, a second stop 412 is disposed around the sidewall of the second body 41. The side face of the second stop 412 facing the housing 1 abuts against an end face of the housing 1. The second stop 412 can limit the position of the second cover assembly 4 when the second cover assembly 4 and the housing 1 are assembled, ensuring the accuracy of the position of the second cover assembly 4 in the housing 1.

In an embodiment, as shown in FIG. 3, the electrode connector 32 includes a connection portion 321 and a first stop portion 322. The first stop portion 322 is secured to one end of the connection portion 321. A mounting hole 311 extends through the first body 31. The first body 31 has a first side face and a second side face opposite to each other. The first side face faces the inside of the housing 1. The second side face faces the outside of the housing 1. The first stop portion 322 is disposed on the first side face. The end of the connection portion 321 facing away from the first stop portion 322 extends through the mounting hole 311 and to the second side face. The first insulator 33 is disposed between the connection portion 321 and the hole wall of the mounting hole 311. The second insulator 34 is disposed between the first stop portion 322 and the first body 31. The T-type electrode connector 32 can be well assembled to the first body 31 and provide welding positions for the tabs of the cell 2. The first insulator 33 and the second insulator 34 can prevent electrical conduction between the electrode connector 32 and the first body 31 and thus prevent electrical conduction between the electrode connector 32 and the housing 1.

In this embodiment, a second stop portion 36 is disposed at the end of the connection portion 321 facing away from the first stop portion 322, the second stop portion 36 and the first stop portion 322 are disposed on two sides of the first body 31, and a third insulator 35 is disposed between the second stop portion 36 and the first body 31. The second stop portion 36 can increase the area of the position where the battery is connected to an external power supply and thus improve the reliability of electrical conduction. The third insulator 35 can prevent electrical conduction between the second stop portion 36 and the first body 31.

In an embodiment, the connection portion 321 is riveted to the second stop portion 36.

In an embodiment, the first insulator 33, the second insulator 34, and the third insulator 35 are integrally injection molded from plastic. The three insulators integrally injection molded can effectively reduce the assembly difficulty and ensure the reliability of sealing and insulation. In this manner, the first cover assembly 3 is assembled to form an integral structure, thereby facilitating the assembly of the first cover assembly 3 and the housing 1.

In this embodiment, an integral structure composed of the first insulator 33, the second insulator 34, and the third insulator 35 is made from polyethylene (PE), polypropylene (PP), polytetrafluoro ethylene (PFA), polybutylene terephathalate (PBT), polyphenylene sulphide (PPS), or another electrically insulating plastic.

PE is a thermoplastic resin prepared by polymerization of ethylene. Industrially, PE also includes a copolymer of ethylene and a small amount of alpha-olefin. Polyethylene is odorless and non-toxic, feels like wax, has excellent low-temperature resistance (the lowest operating temperature can reach −100° C. to −70° C.) and good chemical stability, and can withstand most acids and alkalis. Polyethylene is insoluble in a common solvent at ambient temperature and has a low water absorbability and an excellent electrical insulating power.

PP is a polymer formed by addition polymerization of propylene. PP is a white waxy material that is light in eight and transparent in appearance. PP is flammable, has a melting point of 165° C., softens at 155° C., and has an operating temperature range of −30° C. to 140° C.

PFA (also known as perfluoroalkylate or soluble polytetrafluoroethylene) is a copolymer of a small amount of perfluoropropyl perfluorovinyl ether and polytetrafluoroethylene. PFA has enhanced melt adhesion and reduced melt viscosity. PFA has the same performance as polytetrafluoroethylene. This resin may be processed into a product by using an ordinary thermoplastic molding method. PFA has long been used in an environment where the temperature is from −200° C. to 260° C. PFA has excellent chemical-corrosion resistance to all chemicals, has the lowest coefficient of friction among plastics, and has excellent electrical properties. Electrical insulation of PFA is not affected by temperature. PFA is known as the king of plastics. In terms of chemical resistance, PFA is similar to polytetrafluoroethylene and better than vinylidene fluoride. In terms of creep resistance and compressive strength, PFA is better than polytetrafluoroethylene. PFA has a tensile strength in that the elongation percentage of PFA can reach up to 100% to 300%. PFA has a good dielectric property, an excellent radiation resistance, and a high fire resistance. PFA is non-toxic, physiologically inert, and implantable in a human body.

In an embodiment, the assembly process of the battery is as follows:

In S100, as shown in FIG. 3, the electrode connector 32, the first body 31, and the second stop portion 36 are assembled such that the end of the connection portion 321 of the electrode connector 32 facing away from the first stop portion 322 is riveted to the second stop portion 36, an insulator is injection molded between the electrode connector 32 and the first body 31, and an insulator is injection molded between the second stop portion 36 and the first body 31 so that the electrode connector 32, the first body 31, and the second stop portion 36 are assembled into an integral first cover assembly 3.

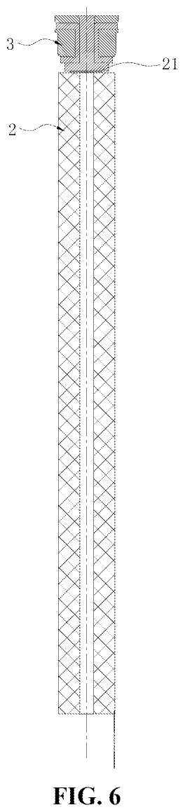

In S200, as shown in FIG. 6, the cell 2 is wound such that the positive tab 21 of the cell 2 is welded to the first stop portion 322 (that is, the electrode connector 32) of the first cover assembly 3.

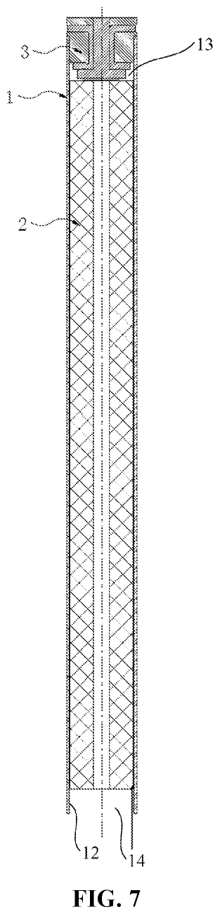

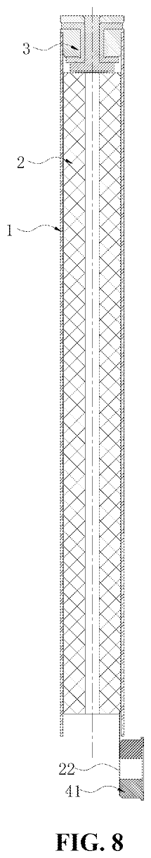

In S300, as shown in FIG. 7, the cell 2 and the first cover assembly 3 are assembled into the housing 1, and welding is performed from the outer sidewall of the housing 1 so that the first body 31 is welded to the housing 1.

In S400, as shown in FIG. 8, the negative tab 22 of the cell 2 is welded to the second body 41 of the second cover assembly 4.

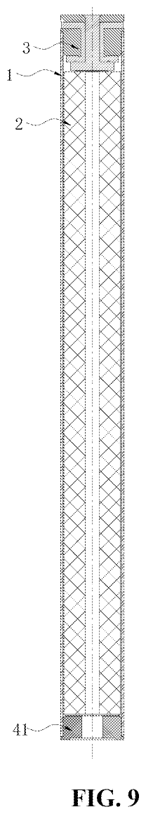

In S500, as shown in FIG. 9, the second body 41 is assembled into the opening at another end of the housing 1, and welding is performed from the outer sidewall of the housing 1 so that the second body 41 is welded to the housing 1.

In S600, an electrolyte injection and battery formation are performed.

In S700, as shown in FIG. 1, the plug plate 42 is welded to the second body 41 to plug the electrolyte filling hole 411.

In the description of the present application, it is to be understood that the orientation or position relationships indicated by terms “above” and the like are the orientation or position relationships shown in the drawings, merely for ease of description and simplifying operations, and these relationships do not indicate or imply that the referred device or component has a specific orientation and is constructed and operated in a specific orientation, and thus it is not to be construed as a limitation to the present application.

In the description of the specification, the description of reference terms “an embodiment” and the like means that specific features, structures, materials or characteristics described in connection with the embodiment are included in at least one embodiment or example of the present application. In the specification, the schematic representation of the preceding terms does not necessarily refer to the same embodiment.

1. A battery, comprising:
a housing internally provided with a receiving chamber;
a cell mounted in the receiving chamber;
a first cover assembly comprising a first body and an electrode connector disposed on, connected to, and insulated from the first body, wherein the first body is configured to be inserted in the housing, and a sidewall of the first body is welded to a sidewall of the housing; and
a second cover assembly comprising a second body, wherein the second body is configured to be inserted in the housing, and a sidewall of the second body is welded to the sidewall of the housing;
wherein two ends of the housing are each provided with an opening, the opening at one of the two ends is plugged by the first cover assembly, and the opening at another of the two ends is plugged by the second cover assembly; and
wherein the cell is provided with two tabs, one of the two tabs is connected to the electrode connector, and another of the two tabs is connected to the second body.

2. The battery of claim 1, wherein an electrolyte filling hole extends through the second body and is plugged by a plug.

3. The battery of claim 1, wherein a first stop is disposed around the sidewall of the first body, and a side face of the first stop facing the housing abuts against an end face of the housing.

4. The battery of claim 1, wherein a second stop is disposed around the sidewall of the second body, and a side face of the second stop facing the housing abuts against an end face of the housing.

5. The battery of claim 1, further comprising a first insulator and a second insulator, wherein the electrode connector comprises a connection portion and a first stop portion, the first stop portion is secured to one end of the connection portion, a mounting hole extends through the first body, the first body has a first side face and a second side face opposite to each other, the first side face faces an inside of the housing, the second side face faces an outside of the housing, the first stop portion is disposed on the first preliminary amendments for US side face, and an end of the connection portion facing away from the first stop portion extends through the mounting hole and to the second side face; and
the first insulator is disposed between the connection portion and a hole wall of the mounting hole, and the second insulator is disposed between the first stop portion and the first body.

6. The battery of claim 5, further comprising a third insulator, wherein a second stop portion is disposed at the end of the connection portion facing away from the first stop portion, the second stop portion and the first stop portion are disposed on two sides of the first body, and the third insulator is disposed between the second stop portion and the first body.

7. The battery of claim 6, wherein the first insulator, the second insulator, and the third insulator are integrally injection molded from plastic.

8. The battery of claim 1, wherein the housing is cylindrical and has a height-to-diameter ratio of greater than or equal to 2:1.

9. The battery of claim 8, wherein the housing has a diameter of less than 5 mm and greater than 0 mm.

10. The battery of claim 9, wherein the housing has a diameter of 3 mm.

11. The battery of claim 2, further comprising a first insulator and a second insulator, wherein the electrode connector comprises a connection portion and a first stop portion, the first stop portion is secured to one end of the connection portion, a mounting hole extends through the first body, the first body has a first side face and a second side face opposite to each other, the first side face faces an inside of the housing, the second side face faces an outside of the housing, the first stop portion is disposed on the first side face, and an end of the connection portion facing away from the first stop portion extends through the mounting hole and to the second side face; and
the first insulator is disposed between the connection portion and a hole wall of the mounting hole, and the second insulator is disposed between the first stop portion and the first body.

12. The battery of claim 3, further comprising a first insulator and a second insulator, wherein the electrode connector comprises a connection portion and a first stop portion, the first stop portion is secured to one end of the connection portion, a mounting hole extends through the first body, the first body has a first side face and a second side face opposite to each other, the first side face faces an inside of the housing, the second side face faces an outside of the housing, the first stop portion is disposed on the first side face, and an end of the connection preliminary amendments for US portion facing away from the first stop portion extends through the mounting hole and to the second side face; and
the first insulator is disposed between the connection portion and a hole wall of the mounting hole, and the second insulator is disposed between the first stop portion and the first body.

13. The battery of claim 4, further comprising a first insulator and a second insulator, wherein the electrode connector comprises a connection portion and a first stop portion, the first stop portion is secured to one end of the connection portion, a mounting hole extends through the first body, the first body has a first side face and a second side face opposite to each other, the first side face faces an inside of the housing, the second side face faces an outside of the housing, the first stop portion is disposed on the first side face, and an end of the connection portion facing away from the first stop portion extends through the mounting hole and to the second side face; and
the first insulator is disposed between the connection portion and a hole wall of the mounting hole, and the second insulator is disposed between the first stop portion and the first body.
